(19) United States
(12) Patent Application Publication
(10) Pub. No.: US 2013/0060463 A1
(43) Pub. Date: Mar. 7, 2013

(54) METHOD, APPARATUS AND COMPUTER PROGRAM FOR SELECTING AND DISPLAYING ROUTE FAVORABLE TO DRIVER

(71) Applicants: Mikael Folke Onsjö, Kanagawa-ken (JP); Takayuki Osogami, Kanagawa-ken (JP)

(72) Inventors: Mikael Folke Onsjö, Kanagawa-ken (JP); Takayuki Osogami, Kanagawa-ken (JP)

(73) Assignee: International Business Machines Corporation, Armonk, NY (US)

(21) Appl. No.: 13/603,975

(22) Filed: Sep. 5, 2012

(30) Foreign Application Priority Data
Sep. 6, 2011 (JP) 2011-193609

(51) Int. Cl. G01C 21/34

(52) U.S. Cl. 701/428

(57) ABSTRACT

A method and apparatus for selecting and displaying a route preferable to a driver while reducing the frequency of changing the route. A dynamic strategy is computed which depends on time required to reach each intersection to be passed through between a departure place and a destination place. A probability distribution of the required time for each intersection and a driving direction to be selected is computed according to the computed dynamic strategy. A driving direction having the highest probability of the required time is sequentially selected to determine intersections to be passed through to the destination. At each intersection, the probability of the required time for each driving direction can be added and a driving direction that has the highest total probability among the results of the additions can be sequentially selected.

### CROSS-REFERENCE TO RELATED APPLICATION

This application claims priority under 35 U.S.C. §119 from Japanese Patent Application No. 2011-193609 filed Sep. 6, 2011, the entire contents of which are incorporated herein by reference.

### BACKGROUND OF THE INVENTION

1. Field of the Invention

The present invention relates to a method, an apparatus, and a computer program for selecting and displaying a route preferable to a driver while reducing the frequency of changing the route.

2. Description of Related Art

Today's car navigation systems include routing algorithms that are creatively designed in various ways to enable the systems to select and display routes favorable to drivers. For example, JP2002-190091A, JP2002-286480A, JP2003-337036A, and JP2005-037246A disclose car navigation systems that select a route most favorable to a driver on the basis of static information. Some systems are disclosed that display multiple candidate routes based on static information to allow a driver to select from among the displayed candidate routes and display the optimum route.

Techniques to select a route using the probability distribution of an event that can occur in the future, in addition to static information, have been developed. For example, Q. Wu, J. Hartley, D. Al-Dabass: Time-Dependent Stochastic Shortest Path(s). I. J. of Simulation, vol. 6, No. 7-8 2005 and E. D. Miller, H. S. Mahmassani, A. Ziliaskopoulos: Path search techniques for transportation networks with time-dependent, stochastic arc costs. IEEE Int. Conference on Systems, Man, and Cybernetics: ‘Humans, Information and Technology’ 1994 disclose systems that acquire data such as probe car data and fixed-point observation data and use uncertainty (a probability distribution) of travel (drive) times or dynamic information such as a congestion forecast to select a more favorable route.

However, if a route selected according to static information is displayed as in JP2002-190091A, JP2002-286480A, JP2003-337036A, and JP2005-037246A, the displayed route can be frequently changed. This is because the route is researched if a road that was not congested at the time of departure is driven in a time period prone to traffic congestion or driven when the road actually has traffic congestion. A route change is stressful for a driver, and frequent route changes can result in an inefficient route selection.

Even if a route selected according to dynamic information is displayed, it is difficult to make a driver understand displayed information for which the driver cannot respond immediately, such that “Take the route A if you arrive before x o'clock, or the route B otherwise.” Consequently, an optimum route is selected among route candidates based on static information. Thus, frequent route changes can result in an inefficient route selection.

The present invention has been made in the light of the above circumstances, and an object of the present invention is to provide a method, an apparatus, and a computer program for selecting and displaying a route preferable to a driver, which are capable of selecting an efficient route while avoiding frequent route changes during driving.

### SUMMARY OF THE INVENTION

According to a first aspect of the invention, a method implementable in an apparatus that selects and displays a route for a driver is provided. The method includes computing a dynamic strategy depending on a time required to reach each intersection potentially passed through between a departure place and a destination place, computing, according to the computed dynamic strategy, a probability distribution of the required time for each intersection and a driving direction to be selected depending on the required time, and selecting, sequentially, a driving direction having the highest probability of the required time to determine intersections to be passed through to the destination place.

According to a second aspect of the invention, an apparatus that selects and displays a route for a driver is provided. The apparatus includes a dynamic strategy computing unit that computes a dynamic strategy depending on a time required to reach each intersection potentially passed through between a departure place and a destination place, a driving direction computing unit that computes, according to the computed dynamic strategy, a probability distribution of the required time for each intersection and a driving direction to be selected depending on the required time, and an intersection determining unit that sequentially selects a driving direction having the highest probability of the required time to determine intersections to be passed through to the destination place.

According to a third aspect of the invention, a computer readable storage medium tangibly embodying a computer readable program code having computer readable instructions which, when implemented, cause a computer to carry out the steps of a method that selects and displays a route for a driver is provided. The method includes computing a dynamic strategy depending on a time required to reach each intersection potentially passed through between a departure place and a destination place, computing, according to the computed dynamic strategy, a probability distribution of the required time for each intersection and a driving direction to be selected depending on the required time, and selecting, sequentially, a driving direction having the highest probability of the required time to determine intersections to be passed through to the destination place.

### BRIEF DESCRIPTION OF THE DRAWINGS

FIG. 1 is a block diagram illustrating a configuration of a route selecting apparatus according to a first embodiment of the present invention;

FIG. 2(a) is a functional block diagram of the route selecting apparatus according to the first embodiment of the present invention;

FIG. 2(b) is a table of computation results according to the first embodiment of the present invention;

FIG. 3 is a diagram illustrating an exemplary probabilistic model based on a simple road model;

FIG. 4 is a table listing examples of expected required times for routes selected by the route selecting apparatus according to the first embodiment of the present invention;

FIG. 5 is a table listing examples of roads selected in association with “Middle Town” according to an optimum dynamic strategy on the route selecting apparatus according to the first embodiment of the present invention;

FIG. 6 is a table listing exemplary probabilities of route change on the route selecting apparatus according to the first embodiment of the present invention;

FIG. 7 is a flowchart of a process procedure performed by a CPU of the route selecting apparatus according to the first embodiment of the present invention;

FIG. 8 is a functional block diagram of a route selecting apparatus according to a second embodiment of the present invention; and

FIG. 9 is a flowchart of a process procedure performed by a CPU of the route selecting apparatus according to the second embodiment of the present invention.

### DETAILED DESCRIPTION OF THE PREFERRED EMBODIMENTS

According to the present invention, the probability distribution of time required for traveling between intersections through which a vehicle is likely to travel between a departure place and a destination is obtained for each driving direction at an intersection, that is, for each of adjacent intersections to which the driver can drive. Even if a traffic congestion time period is reached during driving, that event has been expected during computation of the probability and therefore a route does not need to be searched for anew and the chances of unexpected route change are little. The driver is allowed to select an efficient route on the basis of dynamic information without displaying information about which the user cannot make quick determination, such as “Take road A if you arrive before x o'clock, or take road B otherwise”.

Apparatuses capable of selecting and displaying a route favorable to a driver while reducing the frequency of route changes according to embodiments of the present invention will be described below in detail with reference to drawings. It will be understood that the embodiment described below is not intended to limit the present invention disclosed in the scope of claims and that not all of the combinations of features described in the embodiment are essential to the solution to the problems.

The present invention can be carried out in many different modes and should not be interpreted as being limited to the specifics of the embodiment described. Throughout the embodiment, like elements are given like reference numerals.

While an apparatus in which a computer program is installed in a computer system will be described with the embodiment given below, part of the present invention can be implemented as a computer-executable computer program as will be apparent to those skilled in the art. The present invention can be implemented by hardware as an apparatus capable of selecting and displaying a route favorable to a driver while reducing the frequency of route changes, or software, or a combination of software and hardware. The computer program can be recorded on any computer-readable recording medium, such as a hard disk, a DVD, a CD, an optical storage device, or a magnetic storage device.

The probability distribution of time required for traveling between intersections through which a vehicle is likely to travel between a departure place and a destination is obtained for each driving direction at an intersection for each of adjacent intersections to which the driver can drive. Even if a traffic congestion time period is reached during driving, that event has been expected during computation of the probability. A new route does not need to be searched and the chances of unexpected route change are little. The driver is allowed to select an efficient route on the basis of dynamic information without displaying information about which the user cannot make quick determination, such as “Take road A if you arrive before x o'clock, or take road B otherwise”.

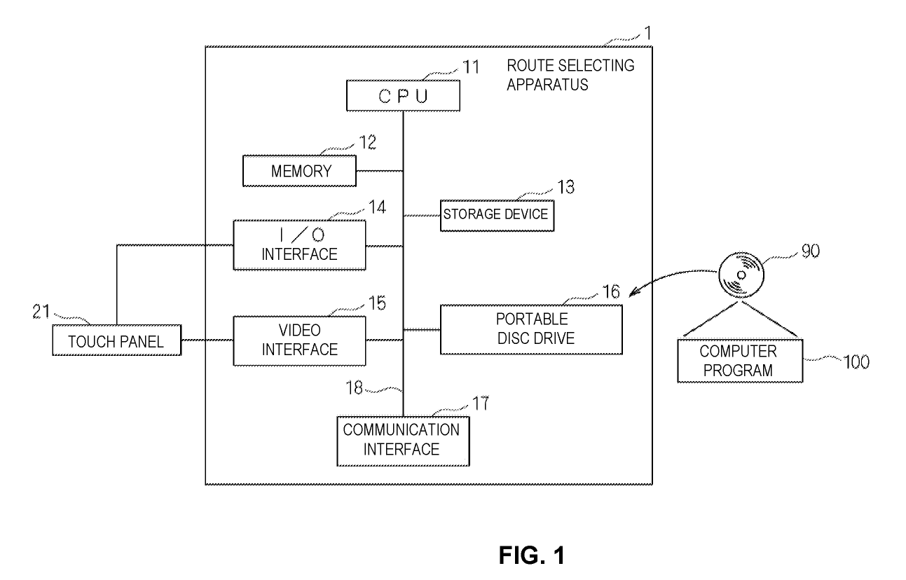

FIG. 1 is a block diagram illustrating a configuration of a route selecting apparatus according to a first embodiment of the present invention. The route selecting apparatus 1 according to the first embodiment of the present invention includes at least a CPU (central processing unit) 11, a memory 12, a storage device 13, an I/O interface 14, a video interface 15, a portable disc drive 16, a communication interface 17, and an internal bus 18 interconnecting the hardware components given above.

The CPU 11 is connected to the hardware components of the route selecting apparatus 1 given above through the internal bus 18, controls operations of the hardware components given above, and executes various software functions according to a computer program 100 stored on the storage device 13. The memory 12 is implemented by a volatile memory such as an SRAM or an SDRAM, in which a load module of the computer program 100 is loaded when the computer program 100 is executed and temporary data generated during execution of the computer program 100 is stored.

The storage device 13 is implemented by a storage device such as a built-in fixed storage device (a hard disk) or ROM. The computer program 100 stored in the storage device 13 has been downloaded from a portable storage medium 90, such as a DVD or a CD-ROM, on which information such as programs and data are stored, by the portable disc drive 16, and is loaded into the memory 12 from the storage device 13 when the computer program 100 is executed. The computer program 100 can be downloaded from an external computer connected through the communication interface 17.

The communication interface 17 is connected to the internal bus 18 and is capable of sending and receiving data to and from an external computer or other device by connecting to an external network such as the Internet, a LAN, or a WAN.

The I/O interface 14 and the video interface 15 are connected to a touch panel 21 implemented by a display such as a liquid-crystal display to display a given image and take an input of information. Input devices such as keyboard and a mouse can also be connected to take inputs.

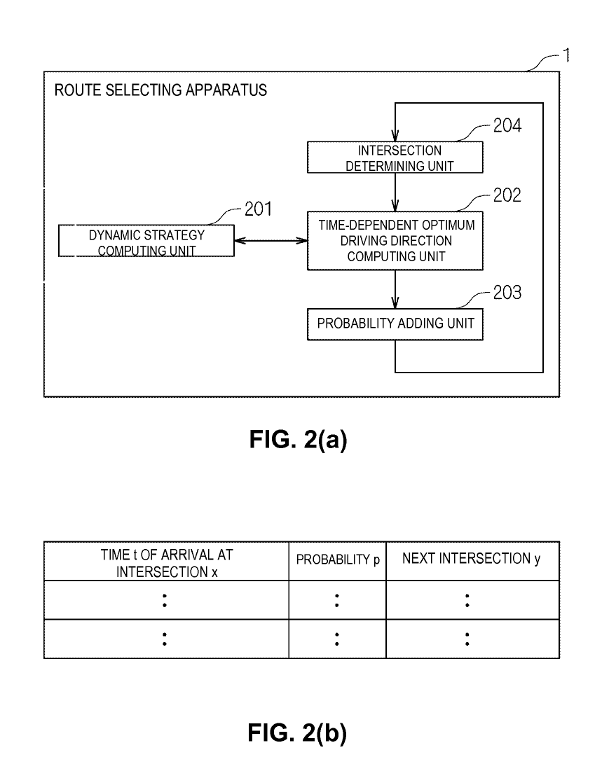

FIG. 2 is a functional block diagram of the route selecting apparatus 1 according to the first embodiment of the present invention. In FIG. 2(a), a dynamic strategy computing unit 201 of the route selecting apparatus 1 computes at every intersection a dynamic strategy that depends on the time required to reach each of other intersections. The term “dynamic strategy” means that at every intersection an optimum next intersection is determined as a driving direction according to the time of arrival at that intersection. For example, at an intersection v₁ that follows departure point (departure place) v₀, the next intersection to reach is determined as a driving direction according to the time of arrival at intersection v₁.

A time-dependent optimum driving direction computing unit (driving direction computing unit) 202 computes the probability p that the time of arrival at each intersection will be t and the next intersection to be selected if the time of arrival at the intersection is t as the driving direction, on the basis of a dynamic strategy computed by the dynamic strategy computing unit 201. The results of computations can be stored in the form of a table in which, for each intersection x, the probability p that the arrival time at the intersection x will be t is associated with the next intersection y to be selected as shown in FIG. 2(b).

A probability adding unit 203 adds, at every next intersection, a computed probability of required time in each driving direction. The probability at every next intersection for every intersection, that is, the probability in every driving direction, can be determined. An intersection determining unit 204 sequentially selects a driving direction that has the highest total probability of required time resulting from the addition by the probability adding unit 203 to determine the next intersection.

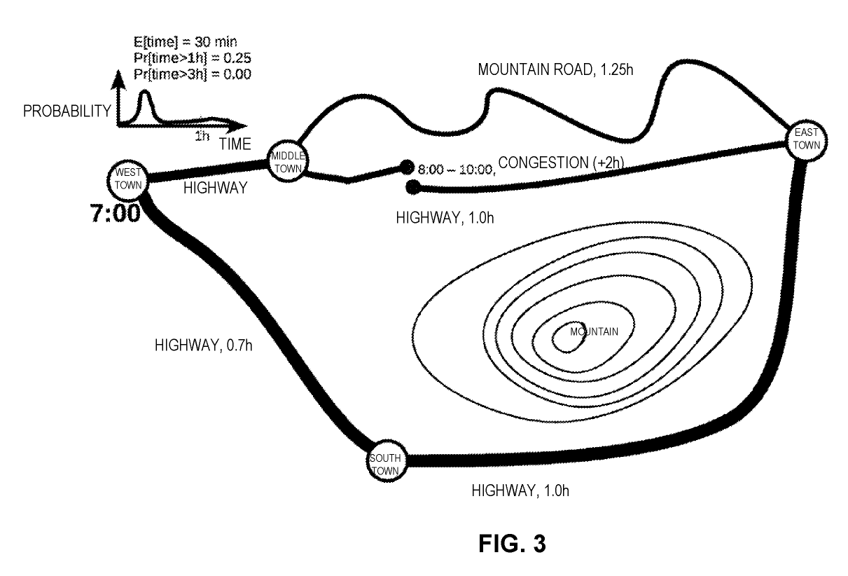

The probability distribution of required time changes with time. FIG. 3 illustrates an exemplary probabilistic model based on a simple road model. It is assumed in FIG. 3 that “West Town” is the departure point, and a driver leaves “West Town” at 7:00 a.m. for “East Town”. The expected value E of time it takes to travel from “West Town” to “Middle Town” is 30 minutes, the probability of taking no less than 1 hour is 0.25, and the probability of taking more no less than 3 hours is 0. If a mountain road is selected, the time it takes to travel from Middle Town to East Town is 1.25 hours; if a highway is selected, the time it takes to travel from Middle Town to East Town is 1.0 hour. If a highway is selected at Middle Town between 8:00 and 10:00, it will take additional 2 hours because of traffic congestion.

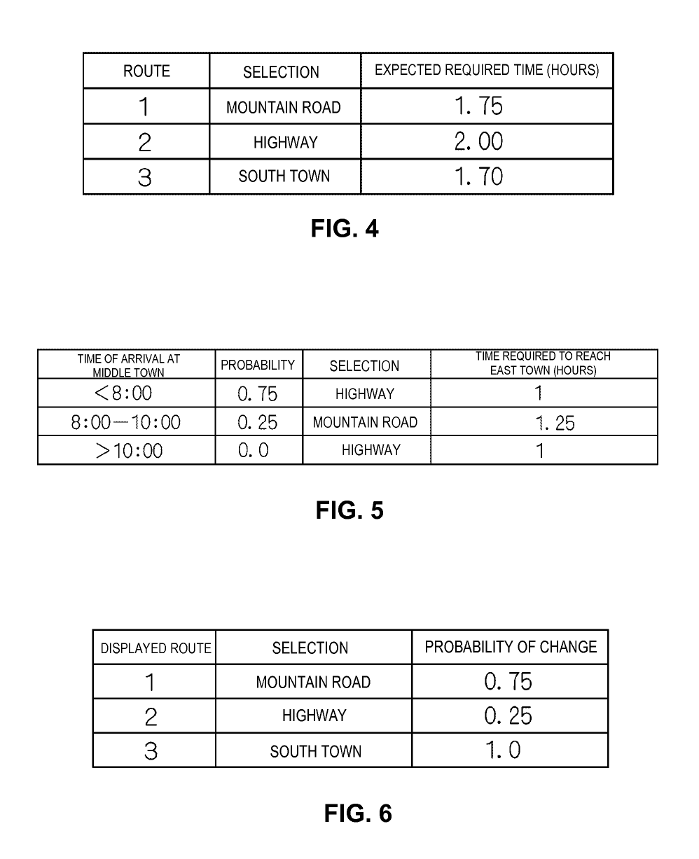

There are three possible routes that can be presented to the driver. FIG. 4 is a table listing examples of expected required times for routes selected by the route selecting apparatus 1 according to the first embodiment of the present invention. One can consider from FIG. 4 that the route ‘3’, which takes the shortest expected required time of 1.70 hours, should be displayed. However, route ‘2’, which takes the longest expected required time of 2.00 hours, is displayed in the present invention. Since the route ‘2’ goes through “Middle Town”, the expected required time for route ‘2’ can be computed from FIG. 3 as: 0.5 hours+(0.75×1.0 hour+0.25×(1.0 hour+2.0 hours)).

First, an optimum dynamic strategy is computed. The optimum dynamic strategy can be computed by a well-known method. If the numbers of intersections and roads available are small, all possible dynamic strategies can be listed and an optimum dynamic strategy can be selected.

FIG. 5 is a table listing examples of roads selected in association with “Middle Town” under an optimum dynamic strategy on the route selecting apparatus 1 according to the first embodiment of the present invention. It is assumed here that when the driver leaves “West Town” at 7:00, the driver first takes the highway for “Middle Town”. In the example in FIG. 5, the probability that the driver will arrive at “Middle Town” before 8:00 is 0.75, which can be seen from FIG. 3. In this case, the time it takes to travel from “Middle Town” to “East Town” on the highway is 1 hour.

The probability of arriving at “Middle Town” between 8:00 and 10:00 is 0.25. In this case, the time it takes to drive from “Middle Town” to “East Town” on the mountain road is 1.25 hours. The probability of arriving at “Middle Town” after 10:00 is 0. In this case, the time it takes to travel from “Middle Town” to “East Town” on the highway is 1 hour.

From the dynamic strategies in FIG. 5, the optimum dynamic strategy is to take the highway from “West Town” to “Middle Town” and then dynamically select a route from “Middle Town” to “East Town” according to the time of arrival at “Middle Town”. The expected required time when the driver drives under this dynamic strategy can be computed as: 0.5 hours+(0.75×1 hour+0.25×1.25 hours)=1.5625 hours. This is shorter than the expected required time for route ‘3’ in FIG. 4.

However, since an optimum dynamic strategy does not indicate a route, information to be presented to the driver needs to be carefully chosen. In the first embodiment, a route is determined and displayed at the time of departure so as to allow the driver to drive according to an optimum dynamic strategy.

According to the dynamic strategy, it is determined first that the highway from “West Town” toward “Middle Town” is displayed as part of the route because the optimum route from “West Town” is the highway leading to “Middle Town”. Then, a probability distribution P of time of arrival at “Middle Town” along the determined route is computed. In FIG. 3, the probability of arrival before 8:00 is 0.75 and the probability of arrival between 8:00 and 10:00 is 0.25.

Then, the probability Qm that the mountain road from “Middle Town” will be selected as a driving direction and the probability Qh that the highway from “Middle Town” will be selected when the driver is driving under the optimum dynamic strategy are computed on the basis of the probability distribution P. For example, the probability that the vehicle will arrive at “Middle Town” before 8:00 is 0.75, and the highway will be selected under the optimum dynamic strategy. Since the probability that the vehicle will arrive at “Middle Town” after 10:00 is 0, the probability of selecting the highway is 0.75 (=0.75+0). Similarly, the probability of selecting the mountain road is 0.25.

Under the optimum dynamic strategy, the route that is most likely to be selected as the driving direction at the time of arrival at “Middle Town” is identified. In the example in FIG. 3, the probability Qh of selecting the highway at “Middle Town” is higher than the probability Qm of selecting the mountain road at “Middle Town”. Therefore, the highway is identified as the driving direction that is most likely to be selected.

At this point in time, the highway from “Middle Town” is displayed additionally as part of the route displayed. Accordingly, the displayed route, “West Town”→Highway→“Middle Town”→Highway→“East Town”, namely Route ‘2’ in FIG. 4, is displayed.

The driver takes route ‘2’ displayed and leaves “West Town”. Immediately before arriving “Middle Town”, determination is made as to whether the time of arrival at “Middle Town” is between 8:00 and 10:00. This is done because the highway is congested with traffic and the mountain road is the best option in the period between 8:00 and 10:00.

If it is determined that the time of arrival at “Middle Town” is between 8:00 and 10:00, the route displayed is changed to the mountain road so that the driver can avoid traffic congestion. If it is determined that the time of arrival at “Middle Town” is before 8:00 or after 10:00, the route displayed is not changed.

Displaying route ‘2’ when the driver leaves “West Town” avoids frequent changes of the route displayed because the probability that the displayed route will be changed, namely the probability that the time of arrival at “Middle Town” will be between 8:00 and 10:00, is as low as 0.25.

FIG. 6 is a table listing exemplary probabilities of route change by the route selecting apparatus 1 according to the first embodiment of the present invention. In FIG. 6, the probability of change of route ‘2’ is 0.25 as described above. Similarly, the probability of change of route ‘1’ is 0.75 (=1−0.25). If route ‘3’ is displayed, the displayed route will be immediately changed, that is, the probability of change is ‘1’, because the optimum dynamic strategy is to travel from “West Town” toward “Middle Town”. Therefore, the probability of change is lowest when route ‘2’ is displayed.

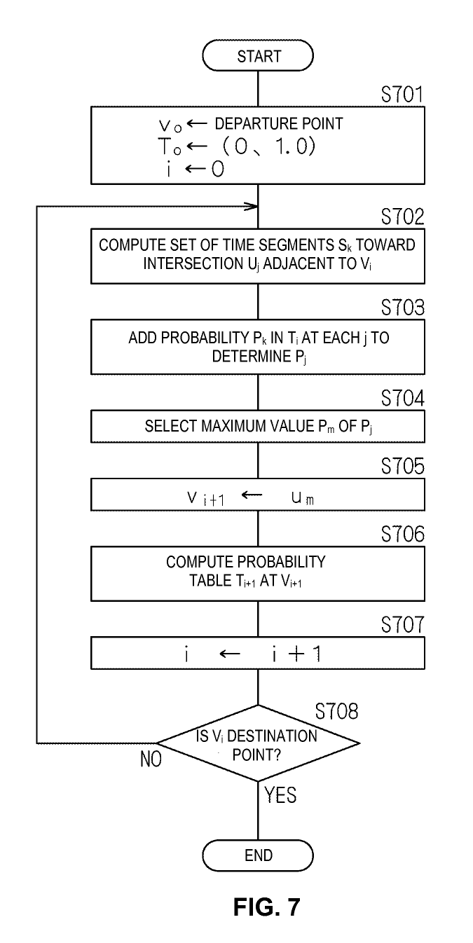

FIG. 7 is a flowchart of a process procedure performed by the CPU 11 of the route selecting apparatus 1 according to the first embodiment of the present invention. In FIG. 7, the CPU 11 of the route selecting apparatus 1 sets initial values (step S701). The CPU 11 sets an intersection v₀ as the departure point, (0, 1.0) as a probability table T₀, and ‘0’ as an argument i. Here, a probability table Tᵢ is a table expressed as a set (Sₖ, pₖ), where Sₖ is a time segment of the time t that has passed since the departure from a departure point and pₖ is the probability in the time segment Sₖ.

The CPU 11 extracts an intersection uⱼ adjacent to an intersection vᵢ as a driving direction and computes a set of time segments Sₖ for traveling toward the extracted intersection uⱼ (step S702). Here, the time segments are the segments of a required time that can be determined from dynamic strategies, such as “before 8:00 a.m.” and “between 8:00 and 10:00” as indicated by the example in FIG. 3.

The CPU 11 adds the probability pₖ in the probability table Ti each time a counter j increments to compute the sum Pⱼ of the probabilities pₖ (step S703). Addition at each j means computing the sum Pⱼ of probabilities pₖ for each intersection uⱼ adjacent to an intersection vᵢ. The Pⱼ thus computed represents the probability that the intersection uⱼ will be the next intersection after the intersection vᵢ has been crossed during driving under the dynamic strategy.

The CPU 11 selects the sum Pₘ, that is the largest among the computed sums Pⱼ of probabilities pₖ (step S704).

The CPU 11 sets the intersection uₘ, corresponding to the computed largest sum Pₘ, as the next intersection vᵢ₊₁ (step S705) and computes a probability table Tᵢ₊₁ for the intersection vᵢ₊₁ (step S706). The CPU 11 increments the argument i by ‘1’ (step S707) and determines whether or not the intersection vᵢ is the destination point (step S708).

If the CPU 11 determines that the intersection vᵢ is not the destination point (step S708: NO), the CPU 11 returns to step S702 and repeats the process described above. If the CPU 11 determines that the intersection vᵢ is the destination point (step S708: YES), the CPU 11 ends the process and displays v₀, v₁, . . . , vᵢ on the touch panel 21 as the route found.

As has been described above, the first embodiment guides a driver to drive under an optimum dynamic strategy while changing a displayed route on the basis of dynamic information such as previous required times in order to allow the driver to drive according to the optimum dynamic strategy. The route displayed is made up of a sequence of intersections that are most likely to be selected when the driver drives under the optimum dynamic strategy or when the driver considers the possibility that a traffic congestion time period will be reached during driving.

Accordingly, the chance that the route displayed will need to be changed due to an unexpected route change is little even when a traffic congestion time is reached during driving, because that event was expected at the time of the determination of the route displayed. Furthermore, since only one route is displayed at any one time to guide the driver without displaying information about which the user cannot make a quick decision, such as “take road A if you arrive before x o'clock, or take road B otherwise”, the driver can select an efficient route on the basis of the dynamic information without fail.

The configuration of a route selecting apparatus 1 according to a second embodiment of the present invention is similar to that of the first embodiment, and therefore like components are given like reference numerals and detailed description of those components will be omitted. The second embodiment differs from the first embodiment in that an intersection corresponding to the most likely required time is selected in the second embodiment.

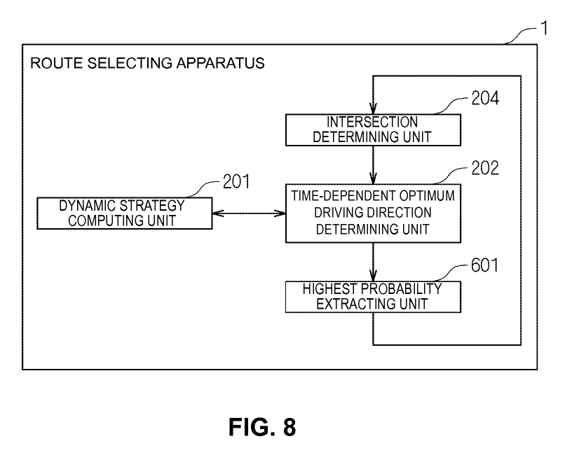

FIG. 8 is a functional block diagram of the route selecting apparatus 1 according to the second embodiment of the present invention. In FIG. 8, a dynamic strategy computing unit 201 of the route selecting apparatus 1 computes at every intersection a dynamic strategy that depends on the time required to reach each of other intersections. For example, at an intersection v₁ that follows departure point (departure place) v₀, the next intersection to reach is determined as a driving direction according to the time of arrival at intersection v₁.

A time-dependent optimum driving direction computing unit (driving direction computing unit) 202 computes the probability p that the time of arrival at each intersection will be t and the next intersection to be selected when the time of arrival at that intersection is t, on the basis of a dynamic strategy computed by the dynamic strategy computing unit 201.

A highest probability extracting unit 601 extracts at each intersection, a required time that has the highest probability in each driving direction. This enables the driving direction that has the highest probability of required time to be determined at each intersection. An intersection determining unit 204 selects the driving direction that has the highest probability to determine the next intersection.

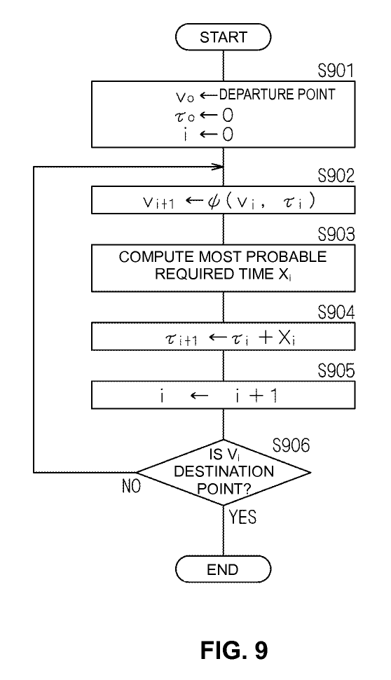

FIG. 9 is a flowchart of a process procedure performed by a CPU 11 of the route selecting apparatus 1 according to the second embodiment of the present invention. In FIG. 9, the CPU 11 of the route selecting apparatus 1 sets initial values (step S901). Specifically, the CPU 11 sets the intersection v₀ as the departure point, ‘0’ as time τ₀ elapsed after leaving the departure point, and ‘0’ as an argument i.

The CPU 11 extracts intersections vᵢ₊₁ adjacent to an intersection vᵢ as driving directions and identifies an intersection v+i₁ in the direction that can be the next driving direction from among the extracted intersections vᵢ₊₁ on the basis of a known dynamic strategy (step S902). Here, φ(vᵢ, τᵢ,) at step S902 in FIG. 9 represents the next possible intersection which is determined by a dynamic strategy computed previously and τᵢ represents the time that has elapsed after the departure from the departure point.

The CPU 11 determines the required time Xᵢ that has the highest probability among the times required to travel along the routes to the identified intersection vᵢ₊₁ (step S903). The CPU 11 then adds the required time Xᵢ to the elapsed time τᵢ to determine elapsed time τᵢ₊₁ (step S904).

The CPU 11 increments the argument i by ‘1’ (step S905) and determines whether or not the intersection vᵢ is the destination point (step S906). If the CPU 11 determines that the intersection vᵢ is not the destination point (step S906: NO), the CPU 11 returns to step S902 and repeats the process described above. If the CPU 11 determines that the intersection vᵢ is the destination point (step S906: YES), the CPU 11 ends the process and displays v₀, v₁, . . . , vᵢ on the touch panel 21 as the route found.

As has been described above, the second embodiment guides a driver to drive under an optimum dynamic strategy while changing a displayed route on the basis of dynamic information such as previous required times in order to allow the driver to drive according to the optimum dynamic strategy. The route displayed is made up of a sequence of intersections that are most likely to be selected when the driver drives under the optimum dynamic strategy or when the driver considers the possibility that a traffic congestion time period will be reached during driving.

Accordingly, the chance that the route displayed will need to be changed due to an unexpected route change is little even when a traffic congestion time is reached during driving, because that event was expected at the time of the determination of the route displayed. Furthermore, since only one route is displayed at any one time to guide the driver without displaying information about which the user cannot make a quick decision, such as “take road A if you arrive before x o'clock, or take road B otherwise”, the driver can select an efficient route on the basis of the dynamic information without fail.

The present invention is not limited to the exemplary embodiments described above. Various modifications and improvements can be made without departing from the spirit of the present invention.

1. A method of selecting and displaying a route for a driver, the method comprising the steps of:
computing a dynamic strategy depending on a time required to reach each intersection potentially passed through between a departure place and a destination place;
computing, according to the computed dynamic strategy, a probability distribution of the required time for each intersection and a driving direction to be selected depending on the required time; and
selecting, sequentially, a driving direction having the highest probability of the required time to determine intersections to be passed through to the destination place.

2. The method according to claim 1, further comprising the step of:
at each intersection, adding the probability of the required time for each of the driving directions, wherein a direction having the highest total probability among the results of the additions is sequentially selected.

3. An apparatus for selecting and displaying a route for a driver, comprising:
a dynamic strategy computing unit that computes a dynamic strategy depending on a time required to reach each intersection potentially passed through between a departure place and a destination place;
a driving direction computing unit that computes, according to the computed dynamic strategy, a probability distribution of the required time for each intersection and a driving direction to be selected depending on the required time; and
an intersection determining unit that sequentially selects a driving direction having the highest probability of the required time to determine intersections to be passed through to the destination place.

4. The apparatus according to claim 3, further comprising:
a probability adding unit adding, at each intersection, the probability of the required time for each driving direction, wherein the intersection determining unit sequentially selects a driving direction having the highest total probability among the results of the additions.

5. A non-transient computer readable storage medium tangibly embodying a computer readable program code having computer readable instructions which, when implemented, cause a computer to carry out the steps of a method of selecting and displaying a route for a driver, the method comprising:
computing a dynamic strategy depending on a time required to reach each intersection potentially passed through between a departure place and a destination place;
computing, according to the computed dynamic strategy, a probability distribution of the required time for each intersection and a driving direction to be selected depending on the required time; and
selecting, sequentially, a driving direction having the highest probability of the required time to determine intersections to be passed through to the destination place.

6. The non-transient computer readable storage medium according to claim 5, further comprising:
at each intersection, adding the probability of the required time for each of the driving directions, wherein a direction having the highest total probability among the results of the additions is sequentially selected.
